(19) United States
(12) Patent Application Publication
(10) Pub. No.: US 2001/0003171 A1
(43) Pub. Date: Jun. 7, 2001

(54) Method for monitoring operation of thermal device and apparatus therefor

(76) Inventors: Tsuneo Sakamoto, Burlington (CA); Nobuyuki Ishizaki, Brantford (CA); Eiji Tasaka, Ichikawa-shi (JP); Keiichi Ogasawara, Matsuyama-shi (JP)

Correspondence Address: BIRCH STEWART KOLASCH & BIRCH, PO BOX 747, FALLS CHURCH, VA, 22040-0747, US

(21) Appl. No.: 09/726,574

(22) Filed: Dec. 1, 2000

(30) Foreign Application Priority Data
Dec. 2, 1999 (JP) 343306/1999

(51) Int. Cl. G06F 15/00

(52) U.S. Cl. 702/187; 702/132

(57) ABSTRACT

The present invention aims at providing a method and apparatus for monitoring operation of a thermal device, which allows accurate understanding of the operating states up until occurrence of a failure. The method includes the steps of: storing in sequence detection data on operating states and detection time thereof as operating state data at specified time intervals; storing detection data and detection time in the event of a failure in a thermal device as point-of-failure data; storing operating state data for a specified period of time including failure occurrence time; and outputting the same. The apparatus is equipped with detection means for detecting operating states, processing means, storage means and output means. The processing means stores in sequence detection data and detection time from the detection means in the storage means as operating state data at specified time intervals, stores detection data and time in the event of a failure in the thermal device in the storage means, stores operating state data for a specified period of time including the failure occurrence time, and outputs stored data to the output means.

### BACKGROUND OF THE INVENTION

The present invention relates to a method for monitoring operation of a thermal device, and an apparatus therefor.

An apparatus for monitoring operation of a thermal device such as a boiler is structured to monitor operating states of the boiler by storing detection data on vapor pressures, water levels, combustion states and exhaust gas temperature, as well as working states of control target devices such as a fuel valve, a blower, and a feed water pump as operating state data at specified time intervals. In the case of a halt of the boiler due to a failure, the operation monitoring apparatus is capable of storing operating state data at the time point of the failure occurrence as point-of-failure data and storing operating state data for a specified period of time until the failure occurs.

The point-of-failure data and the operating state data up to occurrence of a failure stored in the operation monitoring apparatus are used to identify the cause of the failure. However, in the above-mentioned operation monitoring apparatus, the point-of-failure data and the operating state data up to occurrence of a failure are detected and stored at specified intervals, which makes it unclear at which point of time the failure actually occurred. As a result, a change in the operating state of the boiler up to the occurrence of a failure are hard to understand.

In order to identify the time at which a failure occurred and to understand the operating states of the boiler up until the occurrence of the failure with accuracy, it may be conceived to shorten a time interval of storing the operating state data. This solution, however, brings about increase of operating state data to be stored, leading to larger capacity of storage means and heavier load on processing means that process the operating state data.

### SUMMARY OF THE INVENTION

It is an object of the present invention to provide a method and apparatus for monitoring operation of a thermal device, which allows identification of the time of a failure occurrence and precise understanding of a change in the operating state of the thermal device up until the failure occurrence.

The present invention has been invented to solve the above addressed problem. In a first aspect of the invention, there is provided a method for monitoring operation of a thermal device, comprising the steps of: storing in sequence detection data on operating states at specified time intervals and detection time thereof as operating state data; storing detection data on operating states when a failure occurs in a thermal device and failure occurrence time as point-of-failure data; storing operating state data for a specified period of time including the failure occurrence time; and outputting stored operating state data and point-of-failure data.

In a second aspect of the invention, there is provided an apparatus for monitoring operation of a thermal device, comprising: detection means for detecting operating states of a thermal device; processing means, storage means; and output means, wherein the processing means stores in sequence detection data and detection time thereof from the detection means in the storage means as operating state data at specified time intervals, stores detection data on operating states when a failure occurs in the thermal device and failure occurrence time in the storage means as point-of-failure data, stores operating state data for a specified period of time including the failure occurrence time in the storage means, and outputs stored data in the storage means to the output means.

In a third aspect of the invention, the apparatus for monitoring operation of a thermal device further comprises a monitoring side device for receiving the point-of-failure data and the operating state data of the thermal device.

### BRIEF DESCRIPTION OF THE DRAWINGS

FIG. 1 is a schematic view showing an outlined structure of the first embodiment of the present invention;

FIG. 2 is a schematic view showing storage timing of operating state data and point-of-failure data shown in FIG. 1;

FIG. 3 is a schematic view showing operating states of a boiler in the event of failures; and

FIG. 4 is a schematic view showing an outlined structure of the second embodiment of the present invention.

### DETAILED DESCRIPTION OF THE PREFERRED EMBODIMENTS

The embodiments of the present invention will be described hereinafter. Preferred embodiments of the invention are practiced with a thermal device such as a boiler. It will be appreciated that the boiler is structured to detect operating states including a vapor pressure, water level, combustion condition, exhaust gas temperature, and feed water temperature, as well as working states of control target devices such as a fuel valve, a blower, and a feed water pump, based on which automatic operation control is implemented. Upon determination of a failure from each detection data, the boiler is so structured as to stop after executing specified operation, e.g., fire extinction by closing the fuel valve and post-purge by operating the blower for a specified period of time.

The operation monitoring apparatus is equipped with detection means for detecting operating states of the boiler, processing means, storage means and output means. The detection means uses detection means installed in the boiler for automatic control.

The processing means performs sampling of detection data on the operating state from the detection means at specified intervals, and stores in sequence the detection data together with detection time thereof in the storage means as operating state data. In the event of a failure in the boiler, the processing means stores detection data at the time of the failure together with the time thereof in the storage means as point-of-failure data and also stores the operating state data for a specified period of time including the failure occurrence time in the storage means.

Upon an abnormal halt of the boiler, the processing means outputs the data stored in the storage means, e.g., the operating state data and the point-of-failure data, to the output means such as a display device or a printer. The output means displays or prints each detection data, a type thereof, detection time, and failure occurrence time stored in the operating state data and point-of-failure data, preferably in the form of a graph. Displayed or printed operating state data and point-of-failure data are used to understand the operating states of the boiler at the time of the failure. The operating state data and point-of-failure data include each detection time and failure occurrence time, which allows an operator to understand, with accuracy, a change in the operating states of the boiler with the lapse of time before and after the failure occurrence, and facilitates identification of the cause of the failure.

It will be appreciated that the output means may be connected to a control device of the boiler directly or through a monitoring device consisting of a personal computer or the like. When the control device of the boiler incorporates such output means as a display device or printer, it is possible to output the operating state data and point-of-failure data to these output means.

In the present invention, it will also be appreciated that data of each control step and elapsed time from the start of each control step of the boiler may be stored at least in the point-of-failure data. This functionality is provided based on the finding that failures of the boiler are encountered in high frequency during shift of control steps and for a certain period of time after the shift thereof. Accordingly, storing elapsed time data after the start of each control step at least in the point-of-failure data facilitates understanding at which control step and at which point of time after the start thereof a failure occurred.

The elapsed time may be obtained by measuring elapsed time after the start of every control step of the boiler or by storing start time of every control step. Data of each control step and the elapsed time thereof may also be stored in the operating sate data at specified time intervals. In this case, simultaneous monitoring of each control step and the operating states of the boiler is available, which enables management of the operating states and control states of the control device of the boiler, based on the results of the monitoring. Each control step of the boiler herein refers to one operation executed by each control, e.g., pre-purge, ignition of the boiler, change of combustion quantity, and fire extinction executed by a combustion control.

In addition, the boiler may be connected to a monitoring side device for receiving the point-of-failure data and operating state data. The monitoring side device is connected to the boiler through either wire or wireless communications line. The monitoring side device may be installed in the same location or at vicinity of the boiler, or may be installed in a remote location. The monitoring side device may also be connected to a plurality of the boilers, for monitoring the operating states of the boilers and identifying the cause of failures.

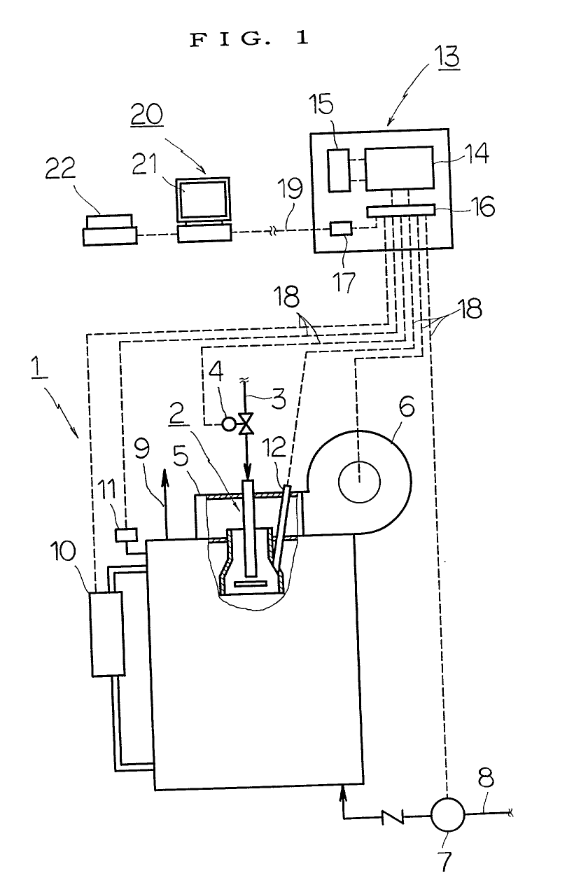

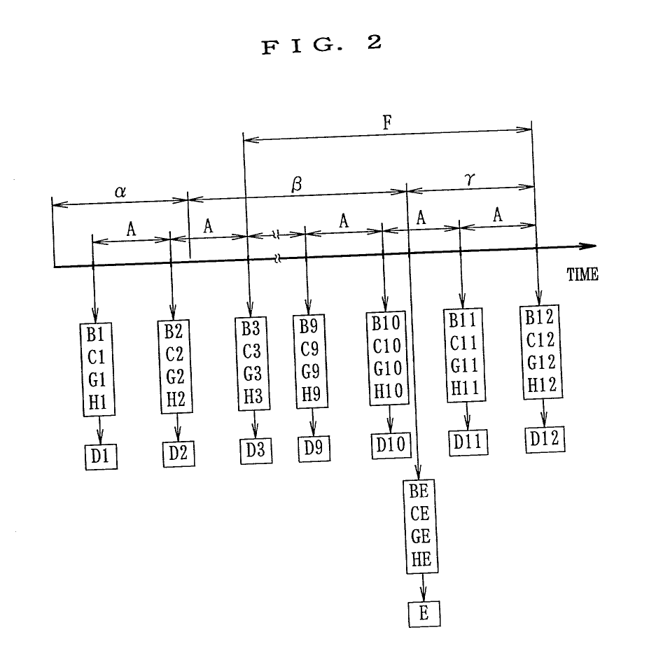

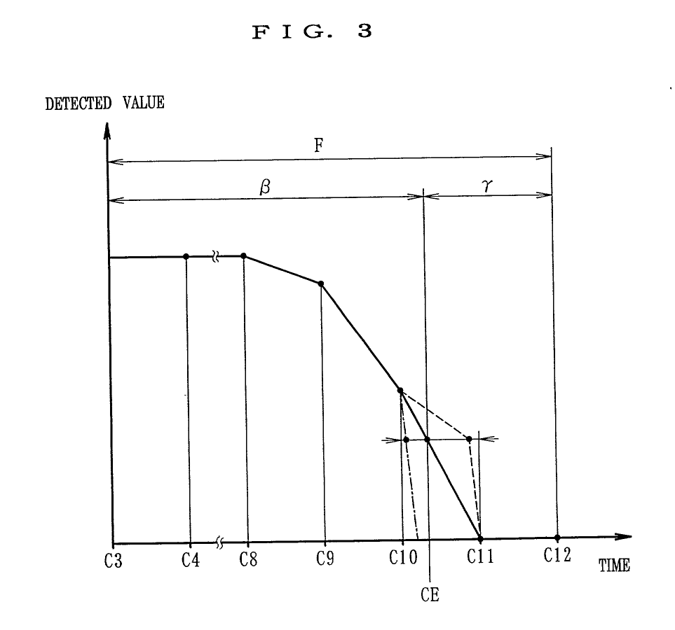

The following description discusses the first embodiment of the present invention with reference to FIGS. 1 to 3. The first embodiment represents application of the present invention as an operation monitoring apparatus of a boiler. FIG. 1 is a schematic diagram showing an outlined structure of the first embodiment in accordance with the present invention. FIG. 2 is a schematic diagram showing storage timing of operating state data and point-of-failure data shown in FIG. 1. FIG. 3 is another schematic diagram showing operating states of a boiler in the event of failures.

In the first embodiment, a boiler 1 is equipped with a burner 2, which is connected to a fuel feed line 3 having a fuel valve 4. The burner 2 is equipped with a blower 6 via a window box 5. The lower side of the boiler 1 is connected to a feed water line 8 having a feed water pump 7, and the upper side of the boiler 1 is connected to a vapor line 9.

The boiler 1 is also equipped with water detection means 10 for detecting water levels in the boiler body and vapor pressure detection means 11 for detecting vapor pressures inside the boiler body. The window box 5 is equipped with flame detection means 12 for detecting states of flames, i.e. combustion states of the burner 2.

The boiler 1 is further equipped with a control device 13 for automatic operation. The control device 13 consists of processing means 14, storage means 15, an input/output device 16 and a communication device 17. The processing means 14 is connected to the storage means 15 and the input/output device 16, which is connected to the communication device 17. The input/output device 16 is further connected to the fuel valve 4, the blower 6, the feed water pump 7, the water level detection means 10, the vapor pressure detection means 11 and the flame detection means 12 via a line 18.

The storage means 15 is for storing an operation control procedure and an operating state monitoring control procedure of the boiler 1 as a program. The storage means 15 is structured to store each detection data from the water level detection means 10, the vapor pressure detection means 11, and the flame detection means 12, as well as each operating state of the fuel valve 4, the blower 6, and the feed water pump 7 as data.

The communication device 17 is connected to a monitoring side device 20 via a wire or wireless communication line 19. The monitoring side device 20 is installed in the location adjacent to the installation site of the boiler 1 like a management station within the same facility as the boiler 1, or a management station distant from the boiler 1. The monitoring side device 20, consisting of, for example, a personal computer, is equipped with a display 21 and a printer 22 as output means.

Description will now be given of control targets of the control device 13 in this embodiment. First of all, description will be given of the automatic operation of the boiler 1. The start of operation of the boiler 1 is instructed by the control device 13. Upon reception of the instruction, the processing means 14 operates the fuel valve 4, the blower 6, and the water feed pump 7 based on the operation control procedure stored in the storage means 15 with reference to each detection signal from the water level detection means 10, the vapor pressure detection means 11 and the flame detection means 12. Control signals from the processing means 14 are outputted to the fuel valve 4, the blower 6 and the feed water pump 7 through the input/output device 16.

Under the automatic operation of the boiler 1, the processing means 14 then performs sampling of operating state detection data B1, B2, . . . at specified time intervals A based on the operation control procedure stored in the storage means 15. The detection data B1, B2, . . . is stored in sequence together with detection time C1, C2 . . . of the detection data B1, B2, . . . in the storage means 15 as operating state data D1, D2, . . . (see FIG. 2).

Te detection data B1, B2, . . . consists of: detection date on a water level, vapor pressure, and a combustion state obtained from each detection signal sent from the water level detection means 10, the vapor pressure detection means 11 and the flame detection means 12, and detection data on operating states of the fuel valve 4, the blower 6 and the feed water pump 7. The operating states of the fuel valve 4, the blower 6 and the feed water pump 7 may be detected based on control signals from the processing means 14, or detected from states of power supply to the fuel valve 4, the blower 6 and the feed water pump 7.

When the operating state data D1, D2, . . . reaches a specified number of units, e.g., 10 units, the processing means 14 erases the oldest operating state data, e.g., D1, and stores new operating state data e.g., D11, to keep the storage means 15 constantly storing a specified unit number of operating state data, i.e. the operating state data for a specified period of time F.

Upon determination of a failure occurred in the boiler 1 based on the detection signals from each detection means 10 to 12, the processing means 14 executes failure control based on the operation control procedure and halts the boiler 1. For example, when a flame detection indicating signal from the flame detection means 12 is deteriorated and undetectable although control to combust the boiler 1 is activated, the processing means 14 closes the fuel valve 4 to stop fuel supply to the burner 2 and drive the blower 6 for a specified period of time for the post-purge.

In the event of a failure of the boiler 1, the processing means 14 stores detection data on operation states BE and failure occurrence time CE in the storage means 15 as point-of-failure data E. The processing means 14 also stores a specified unit number of the operating state data , e.g., two units of D11 and D22, in the storage means 15 after the occurrence of the failure. As a result, there are stored the point-of-failure data E and the operating state data D3 to D12 for a specified period of time F including the failure occurrence time CE in the storage means 15.

The processing means 14 transmits, via the communication device 17, the operating state data D3 to D12 and the point-of-failure data E to the monitoring side device 20. The monitoring side device 20 outputs the operating states of the boiler 1 at the time of occurrence of a failure as well as prior and subsequent thereto to the display 21 or the printer 22 based on the operating state data D3 to D12 and the point-of-failure data E. The output data is preferably converted to the form visually easy to understand like a graph. Thus, an administrator of the boiler can easily determine the cause of a failure of the boiler 1 from the data indicated on the display 21 or printed by the printer 22.

Out of the operating state data D3 to D12 and the point-of-failure data E transmitted to the monitoring side device 20, FIG. 3 describes an example of flame detection data provided by flame detection means 12 displayed or printed with elapsed time. The flame detection means 12 detects a combustion state as a flame currency value. In FIG. 3, the vertical line represents detected flame currency values while the horizontal line represents time.

As described before, the operating state data D3 to D12 and the point-of-failure data E contain the detection time C3 to C12 and the failure occurrence time CE, respectively. Accordingly, detection data detected by the flame detection means 12 that is stored in the operation state data D3 to D12 and the point-of-failure data E can be indicated as a change in the flame currency value before and after the occurrence of a failure corresponding to the detection time C3 to C12 and the failure occurrence time CE, as shown with a solid line in FIG. 3. In FIG. 3, the flame currency value is almost constant during the detection time C3 to C8, then gradually decreases from the detection time C8, and equals to “0” at the detection time C11 and thereafter.

If, as with the conventional apparatus, the failure occurrence time is not stored in the point-of-failure data E, it is not determinable at which point of time between the detection time C10 and C11 the failure occurred. Consequently, it is not determinable how the flame currency value changed before and after the failure occurrence time CE, especially between the detection time C10 and C11. In other word, it is impossible to determine if the flame currency value changed as shown with a solid line in FIG. 3, or if the failure occurred immediately after the detection time C10 and became “0” before the detection time C11 as shown with a dashed line in FIG. 3, or if the failure occurred immediately before the detection time C11 and rapidly descended to “0” before the detection time C11 as shown with a dotted line in FIG. 3. On the other hand, in the first embodiment, the operating data D3 to D12 and the point-of-failure data E contain the detection time C3 to C12 and the failure occurrence time CE, respectively, which provides accurate understanding of the change in the flame currency value with elapsed time before and after the failure occurrence time CE as shown with a solid line in FIG. 3.

In addition to the flame currency value data detected by the flame detection means 12, the operating data D3 to D12 and the point-of-failure data E also contain water level data detected by the water level detected means 10, vapor pressure data detected by the vapor pressure detection means 11, and the operation states of such control target devices as the fuel valve 4, the blower 6 and the feed water pump 7. Consequently, there are available changes with elapsed time not only in the combustion state but also in the states of water level and vapor pressure as well as each operation state of the fuel valve 4, the blower 6 and the feed water pump 7 before and after the failure occurrence time CE. This enables accurate understanding of the operating states of the boiler 1 before and after the failure, thereby facilitating identification of the cause of the failure.

Further in the first embodiment, as shown in FIG. 2, the operating state data D1, D2, . . . and the point-of-failure data E also contain data of G1, G2, . . . at control steps α, β, γ, . . . (hereinafter referred to as “control step data”), and elapsed time data of H1, H2, . . . after the start of each control step α, β, γ, . . . (hereinafter referred to as “elapsed time data”).

This structure is provided based on the finding that failures of the boiler are encountered in high frequency during shift of control steps and for a certain period of time after the shift thereof. As described above, including the control step data G1, G2, . . . GE and the elapsed time data H1, H2, . . . HE in the operating state data D1, D2, . . . and the point-of-failure data E facilitates understanding at which control step α, β, γ, . . . , and at which point of time after the start of the control step α, β, γ, . . . , a failure occurs, thereby facilitating identification of the cause of the failure. In this structure, it is also possible to confirm what kind of processing the control device 13 executed after occurrence of a failure in the boiler 1. According to the structure, simultaneous monitoring of the operating states and each control step α, β, γ, . . . , of the boiler 1 is available, which enables management of the control state of the control device 13 and the operating states of the boiler 1 based on the results of the monitoring.

In this embodiment, the elapsed time data H1, H2, . . . is obtained by measuring elapsed time from the starting point of each control step α, β, γ, . . . whenever the boiler 1 shifts to each control step α, β, γ, . . . . Each control step α, β, γ, . . . herein refers to one control operation, e.g., pre-purge, ignition of the boiler, change of combustion quantity, and fire extinction. For example, if a failure occurs five (5) minutes after the boiler 1 changes the combustion quantity, “change of combustion quantity” is stored as the control step data GE and “5 min.” is stored as the elapsed time data HE in the point-of-failure data E.

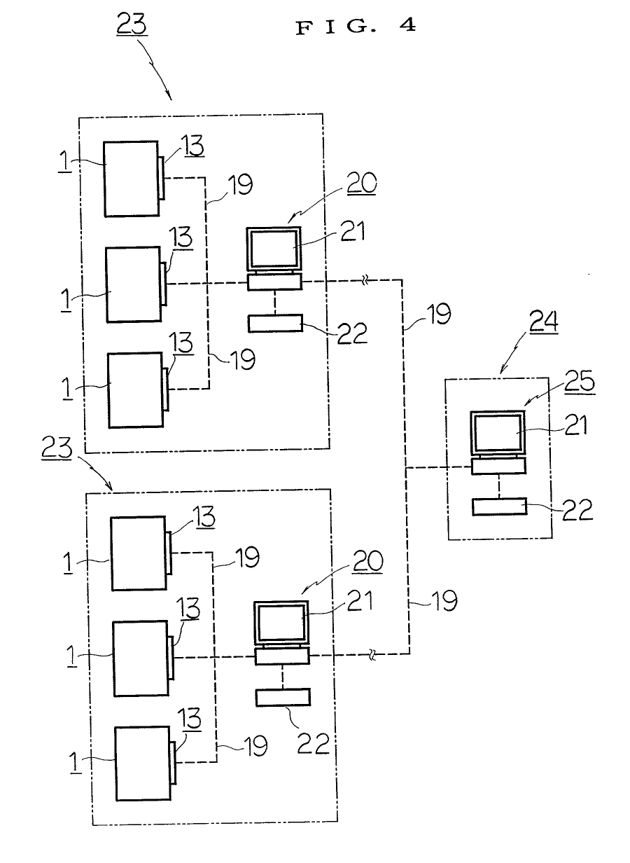

Description will now be given of the second embodiment of the present invention with reference to FIG. 4. FIG. 4 is a schematic diagram showing an outlined structure of the second embodiment according to the present invention. In FIG. 4 showing the second embodiment, the symbols same as those in FIG. 1 showing the first embodiment represent the same members, and therefore detailed description thereof is omitted. In the second embodiment, each boiler 1 in a specified number of boiler installation facilities 23 (two facilities in illustrated second embodiment) is monitored by a management facility 24 installed in a remote site. The boiler 1 is managed based on the results of monitoring by the management facility 24.

The boiler installation facility 23 consists of specified number of the boilers 1 (three units in the second embodiment) and the monitoring side device 20. The monitoring side device 20 in the boiler installation facility 23 monitors and manages the operating state of the boilers 1 in the boiler installation facility 23.

On the other hand, the management facility 24 incorporates a remote monitoring side device 25 having the same structure as the monitoring side device 20. The remote monitoring side device 25 is connected to the monitoring side devices 20 via a communication line 19. A public telephone line or a dedicated telephone line may be used as the communication line 19 connecting between the monitoring side devices 20 and the remote monitoring side device 25.

According to the second embodiment, the monitoring side device 20 monitors the operating states of the boilers 1 in the boiler installation facility 23, and transmits the operating state data of the boilers 1 to the remote monitoring side device 25 through the communication line 19. Thus, the remote monitoring side device 25 can monitor the operating states of the boilers 1 in the boiler installation facility 23.

If either of the boilers 1 encounters with a failure and stops, the operating state data D3 to D12 for a specified period of time F including the failure occurrence time of the boiler 1 that encountered with the failure is stored in the storage means 15 of the boiler 1, and also transmitted to the monitoring side device 20 in the boiler installation facility 23. The monitoring side device 20 then transfers the data to the remote monitoring side device 25.

In the management facility 24, the remote monitoring side device 25 outputs the operating states of the boiler 1 that encountered with the failure before and after the failure occurrence time to the display 21 or the printer 22 to identify the cause of the failure. This way of visual identification of the failure allows a repairer to visit the boiler installation facility 23 with carrying appropriate tools for repair. Accordingly, this embodiment saves the repairer trouble of visiting the boiler installation facility 23 twice: one time for identifying the cause of the trouble; and one time for bringing in appropriate tools for repair, or visiting the boiler installation facility 23 with carrying every tool and material necessary for coping with any expected causes of the failure.

In the second embodiment, the monitoring side device 20 is installed in the boiler installation facility 23. However, it will be understood that the boilers 1 may be directly connected to the remote monitoring side device 25 via the communication line 19 without the monitoring side device 20 installed in the boiler installation facility 23.

As is clear from the above description, the present invention provides accurate understanding of the operating states of the boiler in the event of a failure, thereby enabling identification of the cause of the failure.

What is claimed is:

1. A method for monitoring operation of a thermal device, comprising the steps of: storing in sequence detection data on operating states at specified time intervals and detection time thereof as operating state data; storing detection data on operating states when a failure occurs in a thermal device (1) and failure occurrence time as point-of-failure data; storing operating state data for a specified period of time including the failure occurrence time; and outputting stored operating state data and point-of-failure data.

2. An apparatus for monitoring operation of a thermal device, comprising: detection means for detecting operating states of a thermal device (1); processing means (14), storage means (15); and output means, wherein the processing means (14) stores in sequence detection data and detection time thereof from the detection means in the storage means (15) as operating state data at specified time intervals, stores detection data on operating states when a failure occurs in the thermal device (1) and failure occurrence time in the storage means (15) as point-of-failure data, stores operating state data for a specified period of time including the failure occurrence time in the storage means (15), and outputs stored data in the storage means (15) to the output means.

3. An apparatus for monitoring operation of a thermal device as defined in claim 2, further comprising a monitoring side device (20) for receiving the point-of-failure data and the operating state data of the thermal device (1).
